(19) United States
(12) Patent Application Publication
(10) Pub. No.: US 2007/0007702 A1
(43) Pub. Date: Jan. 11, 2007

(54) DEVICE AND ARRANGEMENT FOR FIXING WORKPIECES

(76) Inventor: Bernhard Brandl, Landsberg am Lech (DE)

Correspondence Address: Schneck & Schneck, P.O. Box 2-E, San Jose, CA, 95109-0005, US

(21) Appl. No.: 11/422,940

(22) Filed: Jun. 8, 2006

(30) Foreign Application Priority Data
Jun. 8, 2005 (DE) DE 102005026346.1

(51) Int. Cl. B25B 1/20

(52) U.S. Cl. 269/37

(57) ABSTRACT

The invention relates to a device for fixing a workpiece, the device comprising at least two arms (13, 15) having at least one clamping axis running between the at least two arms for clamping a workpiece and at least one connecting element (17) holding the at least two arms (13, 15) spaced apart from each other. According to the invention, at least one adjusting device (21, 42, 44, 62, 66) is provided for changing or adjusting the position of a workpiece to be clamped at least perpendicularly to the at least one clamping axis, or for changing or adjusting the position of the at least one clamping axis at least perpendicularly to a workpiece to be clamped.

### FIELD OF THE INVENTION

The invention relates to a device and an arrangement for fixing workpieces as well as a dual arrangement of two devices or arrangements for fixing workpieces and an adjusting means to be used in such a device or arrangement.

### BACKGROUND ART

When processing wood or metal, often two individual workpieces are clamped together by means of one or more screw clamps, in order to connect them to each other for example by adhering or welding. Particularly, if the surface to be connected of two workpieces is small compared to the transverse extension thereof, it is difficult to stably fit a screw clamp and to apply sufficient pressure along the clamping axis without letting down the two workpieces with respect to each other and tripping out of the clamping. When gluing soft woods in addition the problem arises that intermediate layers for protecting the wood are to be clamped between the arms of the screw clamp and the workpiece, such that neat alignment of the screw clamp axis or clamping axis, respectively, with the workpiece is difficult.

Document FR 2 593 422 A1 suggests several versions of clamps usable for the glueing of picture frames or for the spacing of concrete sheathing. Several limbs are hinged, wherein clamping screws are provided at the outer ends of the outermost limbs and concentrically at the elongation limbs. A fixing of the clamp at the picture frame is achieved by the clamping screws arranged at the opposing outer limbs, such that a screw pressure can be built up by the clamping screws at the elongation limbs perpendicularly to the clamping axis between the opposing outer limbs.

Document AT 391 830 B discloses an arrangement having two double action clamping devices and further clamping devices for edge-gluing of squared timber at the front of boards. At the opposing end of two U-shaped arms of the clamping devices rubber-coated cam disks are arranged, which—when clamping a clamping screw—abut on the upper and lower side of the board and thereby wedge when further operating the clamping screw. Thereby, sufficient clamping force is applied by the cam discs between the U-shaped arms, such that by further tightening the clamping the screws press the squared timber to be glued onto the edge of the timber board.

Also document FR 2 527 127 A discloses an edge-gluing arrangement, in which a screw clamp is clamped on the upper and lower sides of a board. Transversely to the clamping direction of the screw clamp runs a beam where clamping screws are arranged, by means of which the edge board is pressed to the front of the board, however, after the clamp screw has been fixedly screwed onto the board.

From document DE 1 094 971 A a clamping arrangement is known, in which screw clamps are laterally clamped to an extensive board. Before tightening the screw clamps, bases are arranged under the screw clamps, between which an elongation rail runs from the one side to the other side of the extensive board. Clamping screws are moveably supported on the elongation rail, by means of which a pressure force is applied to the surface of the extensive board to press smaller workpieces to the extensive board.

The clamping arrangement known from document DE 3 533 355 A1 operates similarly, in which abutting or joining pieces are applied to the opposing side edges of a workpiece to be clamped and are clamped against each other by means of a clamping device running transversely to the workpiece. The connecting rail between the two abutting points supports a moveable clamping element, with which transversely to the direction of the connection rail a pressure force can be applied to the workpiece. Also here, at first the clamping over the connecting rail between the two abutting points has to be built up before the cross clamping device is operable.

From document U.S. Pat. No. 5,094,435 A center device for centering flanges to be welded on a tube end is known. The flange is taken on its circumference by means of several clamping devices, which are then moved over the outer circumference of the tube pipe and serve there the centering of the flange in respect of the tube pipe by adjusting set screws.

Document GB 1 404 150 A describes a U-shaped clamping device having a clamping device arranged at the middle limb. The clamping device comprises a knurled nut, a thread guided by the middle limb and a clamping rail arranged at the outside of the middle limb, which is arranged at the outer side top of the thread. By rotating the knurled nut the clamping rail clamps a profile inserted on the outside of the middle limb between the two flange jaws.

It is an object of the invention to provide a device and an arrangement for fixing workpieces as well as an adjusting aid substantially facilitating the clamping operation even with complex workpieces.

### SUMMARY

According to one embodiment, a device for fixing workpieces with at least two arms is provided, between which a workpiece can be clamped, thus at least one clamping axis runs between the at least two arms. It is understood that the term “clamping axis” also includes a clamping surface or a clamping volume, if, for example, the two arms have two planes lying completely planar to each other, and the arms or one arm is displaced together perpendicularly to the surfaces to clamp the workpiece. Further, starting from a clamping point, is it possible to establish a clamping or pressure axis to plural points lying offset from each other, for example, if the workpiece is clamped between two fixed arms and an arm by a clamping means, wherein two clamping axes result.

The at least two arms are kept spaced apart from each other by at least one connecting element or member, such that the at least one connecting member receives the counterforce upon clamping the workpiece. In addition, the device has at least one adjusting device which can change the position of the workpiece to be clamped at least perpendicularly to the at least one clamping axis. Or as an alternative embodiment the location of the clamping axis (axes) of the at least one clamping device is adapted relative to the workpiece to be clamped by means of the adjusting device. By the adjusting device, the position of the workpiece can be exactly adjusted relative to the clamping points or the clamping line, respectively, or clamping surface. At the same time, the adjusting device serves for storing the workpiece with respect to the device (for example, the workpiece is inserted into the device from the top) or for storing the device at the workpiece (for example, if the device is fitted onto the workpiece from the top). In the alternative embodiment the at least one adjusting device is used for storing the at least one clamping device. Thus, it is no longer required that upon clamping the workpiece has simultaneously to be retained and, if necessary, to be aligned with further clamping aids (such as intermediate layers). That is that an alignment of the position of the workpiece to the clamped is carried out before clamping the workpiece by means of the clamping device(s). With the workpiece being already aligned the clamping is carried out.

In another embodiment, two devices are or can be connected to each other by at least one transverse member or element, wherein at least one adjusting device can be part of the device or part of the assembly. Here, by the one transverse member, the position of the two clamping devices to each other is determined at least temporarily such that clamping the workpiece between at least two clamping axes can be effected. In particular for workpieces, for which clamping is to be effected across a larger surface or across larger intermediate distances, the alignment of the at least two clamping devices with each other also facilitates the clamping operation. Here again, the alignment of the workpiece to be clamped with respect to the clamping axis, preferably with respect to all of the clamping axes, is again achieved through the adjusting device. For example, two clamping devices in form of screw clamps can here be simultaneously actuated and evenly tightened, while the exact alignment of the workpiece with the screw clamps is kept unchanged by the adjusting device. Substantial simplification of the work flow in combination with simultaneously increasing precision thus results for the amateur doing handcrafts or for the workman processing single pieces.

Advantageously, the connecting element or member is a rail connecting the two arms to each other and onto which at least one of the arms is displaceably disposed in rail direction. For cost reasons and for reasons of versatile usability such a device is for example a conventional screw clamp.

Advantageously, the at least one adjusting device is disposed at one or more of the arms, at least at one of the transverse elements or members or at least at one of the connecting members, such that the positional relation between the adjusting device and the clamping points or surfaces, respectively, is determined. Reduction of the required members and fast set-up of the arrangement or device is thereby also achieved. For example, if the adjusting device is disposed at the device in one embodiment, it can be flexibly used as an individual member for resting on the workpiece to be clamped.

In a particularly advantageous embodiment, the at least one adjusting device has a supporting element or member for supporting the workpiece with respect to the clamping device or an arrangement or assembly for aligning the clamping device with the workpiece. Advantageously, the supporting member has a supporting surface or a supporting line, with which the workpiece as a whole comes to rest on the supporting surface or line, or the clamping device or assembly itself is maintained stably aligned (e.g. standing) with respect to the workpiece upon resting on it.

By means of a height adjusting means at the adjusting device, the alignment of the workpiece can be achieved in a particularly simple manner with respect to the clamping axis of the device or assembly. If, for example, plural adjusting devices are provided, inclination of the workpiece with respect to the assembly or device can be adjusted by a height adjusting means at each of the adjusting devices or at an adjusting device with plural height adjusting means, such that alignment is not solely restricted to a height adjustment by translation.

Advantageously, the height adjusting means is for example partially incorporated into the at least one connecting member or element or into the at least one transverse member or element, for example a threaded capsule or a course of thread is provided in the connecting member or in the transverse member, in which a threaded rod is inserted and can be ascended and descended therein by rotating. Or the height adjusting means has a nut or knurled nut running on a threaded section, by means of which for example a transverse beam or a connecting member can be adjusted in height.

If one or more of the adjusting devices are disposed in shiftable or displaceable manner on a transverse member or a connecting member, the adjusting devices can be displaced to each other or to the arms of the device or assembly, respectively, thereby allowing adaptation to the size or shape, respectively, of the workpiece to be clamped. If the workpiece is a frame, for example, an adjusting device can be placed at such a location where the frame rests on the supporting member of the adjusting device.

Instead of a surface support member or element, a supporting member with a supporting point can be provided at least for a part of the adjusting devices, such that also non-flat workpieces can be exactly positioned by the punctual support.

Particularly advantageously, the transverse member or at least one of the transverse members of the assembly or arrangement has a plurality of spaced recesses or fixing members or elements, in which at least one of the clamping devices can be supported for example at one or more of the connecting members or at the clamping arms. For example, the clamping devices are simply inserted into the recesses and thereby aligned in vertical directions, for example perpendicularly standing to the working surface. Instead of or additionally to the recesses, fixing members or elements are provided, or the recesses have fixing members or elements, respectively, by which the clamping devices are or can be temporarily or permanently fixed to the one or more transverse members or elements. In particular, the releasable support of the clamping device or clamping device on the transverse member(s) allows on the basis of the work flow that first the clamping device(s) is (are) inserted into or fixed to the transverse member(s), respectively, the workpiece to be clamped is clamped, and subsequently the workpiece with the clamped clamping devices is removed from the transverse member. Thereby, it is possible to consecutively clamp several workpieces using one and the same transverse member exactly adjusted in position by several screw clamps, and to subsequently deposit them at an appropriate storing place, for example for curing the workpiece. Advantageously, the recesses or fixing members are also distributed raster-like over the longitudinal extension of a transverse member, such that depending on the size of the workpiece or the necessity of several clamping axes the clamping device can be positioned in various distances or across a preset width to each other along the transverse member(s).

Therein, the transverse member(s) or element(s) can connect different members or elements of at least two clamping devices to each other. Herein, it is advantageous, if a transverse member respectively connects the connecting members or elements of the clamping device to each other. In this case, as described above, the clamping devices themselves can be removed from the mount at the transverse member without affecting the function thereof. Advantageously, the transverse member(s) is (are) also designed such that they themselves are free-standing and can therefore receive stably in position one or more clamping devices. Advantageously, the clamping devices are received such that the arms thereof are vertically oriented. However, also positions deviating from the vertical or a pivotable support of a clamping device or the arms thereof, respectively, are provided at the transverse member, such that for example the distances of the clamping axes from adjacent clamping devices can be adjusted by the pivoting capability of the clamping device.

Besides the vertical pivoting capability of a clamping device supported on the transverse member or element, particularly advantageously a pivoting capability of the clamping device in the horizontal plane is provided, for example in that the clamping axis can be pivoted relatively to the longitudinal extension of the transverse member. Thereby, for example the clamping of triangular workpieces is permitted. Alternatively or additionally, the transverse member has recesses or fixing members or elements, by means of which the attachment of the clamping device is effected such that the clamping axes of the clamping devices lie in an angle to each other.

A standing alignment of the device or assembly or arrangement with a working surface is allowed by providing support members or elements at the transverse member(s) or element(s), at the adjusting device(s) and/or at the connecting member(s) or element(s). Thereby, a tipping of the arrangement or device is prevented.

As in a conventional screw clamp, advantageously one of the arms or also both arms of the clamping device is/are displaceable along the connecting means such that the clamping width is adjustable. Displacing both arms at the connecting means allows also clamping stepped workpieces, wherein the steps can be oriented to both sides. Advantageously, an additional joining member is provided connecting at least two arms on one side of at least two clamping devices to each other, such that inserting an intermediate piece is omitted with extended workpieces. Advantageously, the joining member is pivoted on at least one of the arms of the clamping device, such that the joining member can be flatly joined to a lateral edge of the workpiece even with non-parallel, opposing sides of a workpiece.

Advantageously, in the arrangement or device at least three adjusting devices are used, in particular having three or more height adjusting devices, wherein at least three adjusting devices (or height adjusting devices) span a section. I.e. the connecting lines of at least three supporting or resting points for the workpiece to be clamped span a section such that the workpiece to be clamped can be aligned in arbitrary declination in contrast to the clamping axis (axes) of the at least one clamping device.

With the dual assembly or arrangement, it is made possible to provide a very high density of resting points at the clamping device side by side or to perform clamping of a workpiece in various clamping axes and directions at the same time.

For the arrangement of device one or more of the following embodiments are further advantageous, wherein these further embodiments can be realized individually or in combination:

In the arrangement or device at least one fixing element device pivotably supports a clamping device (3, 5) at one of the cross elements (7, 9, 46).

In the arrangement or device at least two clamping devices (3, 5) are or can be supported at the transverse element (7, 9, 46) such that the clamping axes of the two clamping devices (3, 5) run in parallel to each other. In the arrangement or device the at least one transverse element (7, 9, 46, 100) supports the connecting elements (17) of the different clamping devices (3, 5) spaced apart from each other.

In the arrangement or device at least one of the arms (13, 15) can be arranged at the connecting element (17) for moving the arm along a clamping axis direction in variable distance from at least one of the other arms. In the arrangement or device at least one of the arms (13, 15) comprises a clamping element (19) for clamping a workpiece in the at least one clamping axis direction. [23] Advantageously, the clamping element (19) is a threaded spindle.

In the arrangement or device the at least one connecting element (17) is a rail.

In the arrangement or device two arms (13, 15) together with the connecting element (17) form a screw clamp. In the arrangement or device at least one of the arms (13, 15) is fixedly connected to one of the connecting elements (17).

An adjusting means according to another embodiment can for example be provided as a single part to be used in a conventional screw clamp, wherein it can for example then be seated on the rail or on the connecting member of a clamping device or be attached there. Thereby, a conventional screw clamp can be upgraded to another device. In such an adjusting means the designs as described above are correspondingly applicable.

### BRIEF DESCRIPTION OF THE DRAWINGS

FIG. 1 is a perspective view of a lower clamping arrangement according to a first embodiment.

FIG. 2 is a perspective view of an upper clamping arrangement according to a first embodiment.

FIG. 3 is a detailed view of a transverse beam of the arrangements of FIGS. 1 and 2.

FIG. 4 is a perspective view of a lower clamping arrangement according to a second embodiment.

FIG. 5 is a perspective view of an upper (single) clamping arrangement according to a second embodiment.

FIG. 6 is a perspective view of a single clamping arrangement to be used at the bottom or top.

FIG. 7 is a perspective view of a lower clamping arrangement according to a third embodiment.

FIG. 8 is a side view of a clamping arrangement in a fourth embodiment with adjustable clamping axis.

FIG. 9 is a fifth embodiment of a clamping arrangement on a work plate.

### DETAILED DESCRIPTION OF THE INVENTION

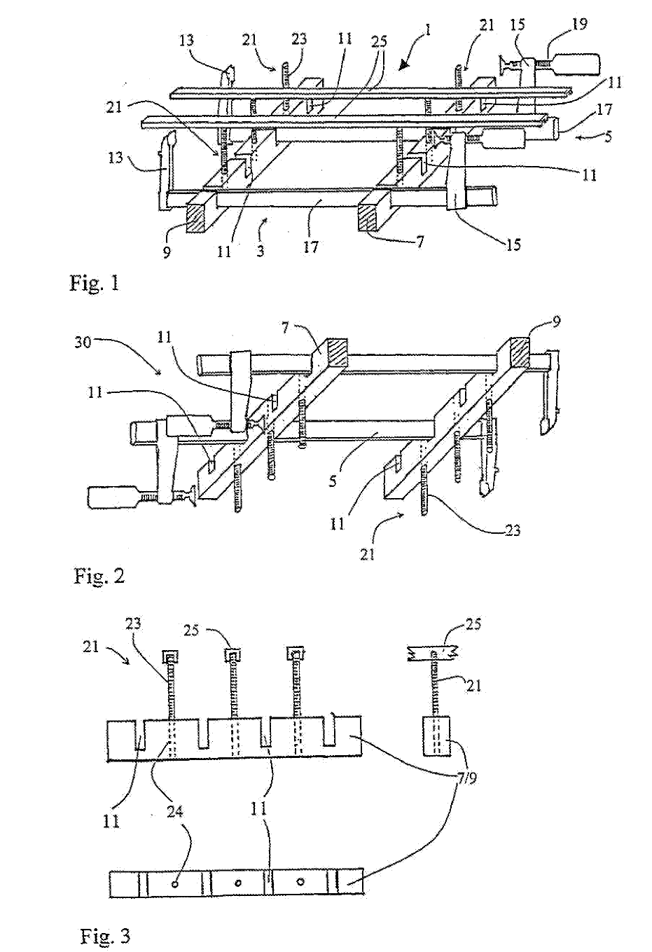

FIG. 1 shows a perspective view of a lower clamping arrangement 1 according to a first embodiment. A first and a second screw clamp 3, 5 are connected to a first and a second transverse beam 7, 9 parallel and spaced apart from each other. In the transverse beams 7, 9, grooves 11 pass transversely to the length axis, each disposed at the transverse beam in spaced apart manner. The first and the second screw clamp 3, 5 are inserted with their rails 17 in respectively one groove of the first and the second transverse beam 7, 9. In the illustrated examples, the screw clamps 3, 5 are loosely inserted into the grooves 11, however, it can also be provided that fixing members of elements, for example a screw inserted next to the grooves 11, are provided for the grooves 11, by means of which the screw clamps 3, 5 are clamped in the grooves 11. The screw clamps 3, 5 are inserted into the grooves 11 such that respectively one fixed clamping arm 13 and one displaceable clamping arm 15 of the screw clamps 3, 5 face vertically upwards. The screw clamps 3, 5 are conventional screw clamps, wherein, if necessary, screw clamps of different length are insertable into the transverse beams 7, 9. The distance of the transverse beams to each other can then correspondingly be adjusted. However, the screw clamps 3, 5 can also have different lengths among each other, for example with workpieces having different clamping widths at the two clamping axes. The screw clamps 3, 5 have each a threaded spindle 19 with a handgrip on one side and a pivoted joining member or element such that the workpiece can be clamped by rotating the threaded spindle.

In addition to the grooves 11 adjusting elements 21 are disposed along the longitudinal axis of the transverse beams 7, 9, the upper end thereof being adjustable relatively to the transverse beams 7, 9 and thus also to the clamping axis between the fixed clamping arm 13 and the displaceable clamping arm 15. As illustrated, respectively three adjusting elements 21 are provided per transverse beam 7, 9. However, more or less adjusting elements can also be provided depending on the geometry, size and shape of the workpiece to be retained. Each of the adjusting elements 21 has a threaded bolt 23, which can be screwed into a threaded sleeve 24 recessed in the transverse beams 7, 9 and adjusted in height therein. As illustrated, U rails 25 are laid on the tops of the threaded bolts 23, wherein they bridge each one threaded bolt 23 of the first transverse beam 7 and one threaded bolt 23 of the second transverse beam 9. Here, the two U rails 25 run parallel to the clamping axes of the screw clamps 3, 5, if the rails 25 are horizontally oriented. However, the U rails 25 can also run transversely to the clamping device or even perpendicularly thereto (be disposed passing in the longitudinal direction of the transverse beams 7, 9).

A workpiece to be clamped with the clamps 3, 5 is laid on the top of the U rails 25 and the workpiece is adjusted in height by rotating the threaded bolts 23 such that the clamping arms 13, 15 or the supporting points thereof, respectively, exactly engage the desired location of the workpiece to be clamped. In a further embodiment, the U rails 25 or one of the rails is equipped with an aligning member or element as in a water balance. In another embodiment of the arrangement to be described below, these water balance elements can also be associated with the screw clamp 3, 5, a transverse beam 7, 9, a supporting element or a rail slider.

FIG. 2 shows a perspective view of a clamping arrangement 30, which can be fitted from the top to a workpiece to be clamped. In an embodiment, the upper clamping arrangement 30 can be combined with the lower clamping arrangement 1 illustrated in FIG. 1, wherein they are oriented at the workpiece with parallel running clamping axes (parallel running screw clamps) or with clamping axes (screw clamps) offset by 90°. In the following, elements being similar or equal to the elements of FIG. 1 are provided with the same reference numerals. It is understood that for example with combined use of the arrangement of FIGS. 1 and 2 more than respectively the two shown screw clamps 3, 5 or only one screw clamp can be employed. In the arrangement 30 of FIG. 2, the threaded bolts 23 are screwed downwards through the transverse beams 7, 9 such that the grooves 11 are still facing upwards, but the distance setting between resting point (tip of the threaded bolts 23) and transverse beam 7, 9 is adjustable towards the bottom starting from the transverse beams. Compared to FIG. 1, the screw clamps 3, 5 are inserted with clamping arms 13, 15 facing downwards. After such a simple upgrade of the arrangement of FIG. 1, the arrangement 30 of FIG. 2 can be fitted onto a workpiece to be clamped from the top. Preferably, the threaded bolts 23 are provided with support bases such that they will not tip on the workpiece to be clamped, and/or the screw clamps 3, 5 are clamped in the grooves 11, as described above. Thus, either the transverse beam 7, 9 are placed standing on the workpiece with the bases at the threaded bolts 23 and the screw clamps 3, 5 are hooked into the grooves, or the arrangement stabilized by the clamped screw clamps 3, 5 (a frame is formed by the screw clamp rails 17 and the transverse beams 7, 9) is seated on the workpiece. Also here, alignment of the clamping axes of the screw clamps 3, 5 relatively to the contact point on the workpiece is again achieved by screwing or unscrewing the threaded bolts 23.

FIG. 3 shows in detail a side view, a front view and a top view of one of the transverse beams 7, 9. As mentioned above, the transverse beams 7, 9 are recessed in threaded sleeves 24, in which the threaded bolts 23 can be screwed and project, according to requirements, upwards (arrangement 1 of FIG. 1) or downwards (arrangement 30 of FIG. 2).

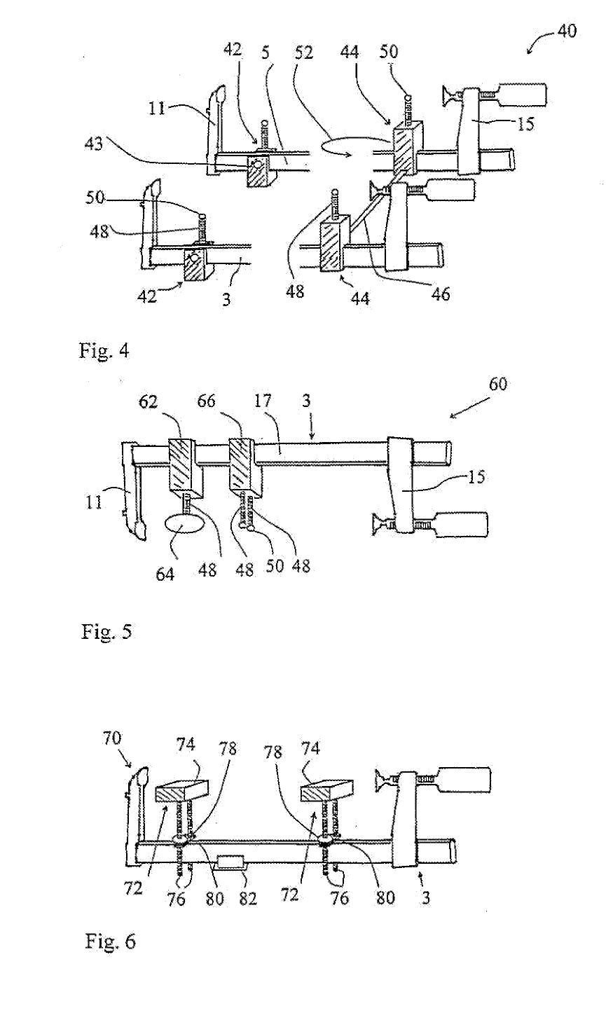

FIG. 4 shows a perspective view of a lower clamping arrangement 40 according to a second embodiment. A first adjusting slider 42 and a second adjusting slider 44 is associated with each screw clamp 3, 5. As indicated in FIG. 4, the first adjusting sliders 42 are fixed to the rail 17 of the screw clamp 3, 5 by means of a screw 43. At the same time, the first adjusting sliders 42 with their bottom side serve as a support base for vertical alignment of the clamping arms 13, 15. The second adjusting sliders 44 are connected to each other through a connecting rod 46. The second adjusting sliders 44 can also be fixedly connected to the rail 17 by fixing means or loosely sit there and be displaced over the rail in the clamping direction. Advantageously, the length of the connecting rod 46 is variable such that the distance between the screw clamps 3, 5 is variable. By providing several connecting rods 46 and several second adjusting sliders 44, more than two screw clamps 3, 5 can be consecutively disposed. The adjusting sliders 42, 44 have threaded bolts 48, wherein the adjusting sliders are disposed such that the threaded bolts 48 project in the direction of the clamping axes of the screw clamps 3, 5 and are adjustable in height by rotating. The upper ends of the threaded bolts 48 are covered with a plastic cap 50 or rubber cap such that no marks are left on sensitive surfaces of the workpieces by rotating the threaded bolts 48. In a further embodiment, a hinged connection 52 is provided on at least one of the second adjusting sliders 44 such that the clamping axes of the two screw clamps 3, 5 are adjustable in angle to each other (in FIG. 4 indicated by the curved arrow 52).

FIG. 5 shows a view of an upper single clamping arrangement 60 according to a second embodiment, wherein a third adjusting slider 62 and a fourth adjusting slider 66 are disposed at a conventional screw clamp 3 at the rail 17. Both sliders 62, 66 are adjustably fixed to the rail 17 of the screw clamp 3, 5 with a clamping means (for example set screw or knurled head screw). The third adjusting slider 62 has a base 64 at the tip of a threaded bolt 48 such that the screw clamp 3 can be placed on the top of a workpiece with the base 64 downwards, such that the screw clamp 3 is and remains aligned with respect to the workpiece. The base 64 is adjustable relative to the body of the third adjusting slider 62 such that again alignment of the clamping axis of the screw clamp 3 with respect to the workpiece is effected. Herein, it can be provided that only the third adjusting slider 62 is provided with a correspondingly great base surface, or additionally, the fourth adjusting slider 66 is employed to effect the alignment of the two contact points of the clamping arms 13, 15 at the workpiece. The fourth adjusting slider 66 has two threaded bolts 48 provided with a cap 50.

FIG. 6 shows a perspective view of a single clamping arrangement 70 usable at the top or bottom at the workpiece. Two fifth adjusting sliders 72 are fitted to the rail 17 of the screw clamp 3 (arrangement at the bottom) or the screw clamp 3 is inserted between threaded bolts 76 of the fifth adjusting sliders 72, which in turn are fitted to the workpiece (arrangement at the top). Each two threaded bolts 76 are fixed to a support plate 74 parallel to each other and spaced apart. A knurled head screw 78 is screwed onto one of the threaded bolts 76, by the height adjustment of which a metal plate 80 having two holes for the threaded bolts 76 can be displaced parallel to the base surface of the support plate 74. By rotating the knurled head screw 78, the height of the support plate 74 with respect to the rail 17 or with respect to the clamping axis between the clamping arms 13, 15 is adjusted, respectively. Upon use at the bottom, optionally a base plate 82 is provided, which can be fixedly connected to the rail 17, for example by a set screw. As with the groove 11 of the transverse beams, the screw clamp 3 can also be loosely inserted into the base plate 82. The base plate 82 prevents a tipping of the screw clamp 3.

The construction of the arrangement shown in FIG. 1 is effected by installation of the transverse beams 7, 9 parallel to each other (in appropriate distance such that the subsequently inserted screw clamps get sufficient support); the screw clamps 3, 5 are inserted into the recesses 11 with the clamping arms upwards; the threaded rods 23 are correspondingly rotated deep into the female threads of the transverse beams—depending on the thickness of the workpiece; the U rails 23 are fitted onto the threaded rods (usually longitudinally to the screw clamps). Thereby, a variable clamping device results now, which is adjustable in height by means of the threaded rods 23 and serves as a support for workpieces (e.g. wood pieces to be glued), which thus can be simply positioned, clamped and glued. The U rails thereby additionally serve as a clamping device in the vertical line (in particular to be used for gluing real woods). The distances between the screw clamps and U rails are selected such that no impairments arise upon use. The height of the workpieces to be processed (e.g. with wood drawers) is largely limited only by the length of the clamping arms of the used screw clamps, since the threaded rods can be screwed arbitrarily deep into the transverse beams.

Here, it is particularly crucial that all of the important and time-critical working operations are performed before the actual gluing operation: the screw clamps are held horizontally (however without the need to be fixed); the contact points of the screw clamps can be adjusted without effort and accurately (therein, these adjustments can be adopted for arbitrarily many other pressing operations); both the workpieces and the additions are simply laid on the supports and finally clamped, wherein fine adjustments can be unproblematicly performed.

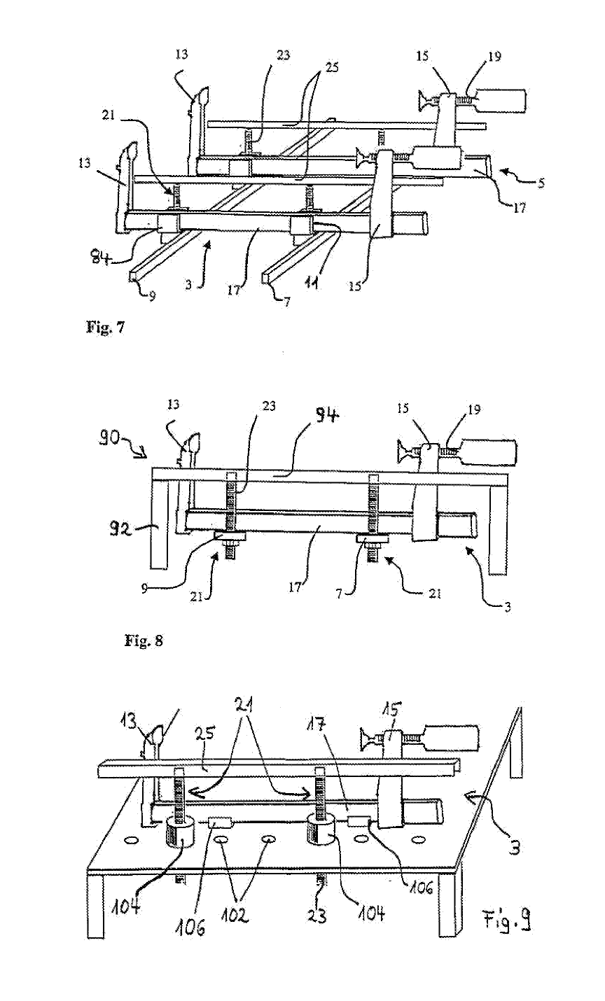

FIG. 7 shows a perspective view of a lower clamping arrangement according to a third embodiment. Equal or equally acting elements have to be provided with the reference numerals as already used above, and in the following only the differences to the first embodiment in FIG. 1 are explained in detail: In the embodiment of FIG. 7 the rails 17 are connected between the clamping arms 13, 15 to the cross supports 7, 9 through connecting bodies 84. The connecting bodies 84 each comprise a groove 11, in which the rails are moveably held. Optionally, the rails can be mechanically fixed in the groove, for example with a clamp screw not shown. The connecting bodies 84 comprise corresponding receptacles (threaded hole/tapped bore in the shown embodiment) height adjustably receiving the adjusting elements. Further, the connecting bodies 84 are moveably connected to the transverse beams 7, 9 such that by shifting the connecting bodies 84 along the transverse beam a simple adaptation to the width of the workpiece to be clamped through the screw clamps 3, 5 is effected, while by shifting the moveable clamping arms 15 an adaptation to the length of the workpiece is effected.

Corresponding to the measurements of the workpiece the distances of the connecting bodies to each other can be adjusted such that the workpiece rests free of shaking in a desired alignment on the rails 25 before the clamping by the clamps 3, 5. As in above examples, the rail 25 is pivotably supported at the tops of the threaded bolts, such that the workpiece can also be “leaningly” aligned before clamping. Leaningly means here that the rails are not aligned parallel to the clamping axis.

FIG. 8 is a side view of a clamping arrangement according to a fourth embodiment comprising an adjustable clamping axis. Equal or equally acting elements have to be provided with the reference numerals as already used above, and in the following only the differences to the first embodiment in FIG. 1 are explained in detail: In inverse operation to the first embodiment here not the workpiece is aligned to the clamping axes of the clamps 3, 5, but the clamping axes of the clamps are aligned in respect of a workpiece by means of the height adjusting devices 21. The workpiece rests on transverse beams 94 (the rear transverse beam can not be seen in the side view) of two portal frames 90 (the rear one again can not be seen) supported by two bases 92. The transverse beams 7, 9 supporting the clamps 3, 5 “hang” on the transverse beams 94 by means of the height adjusting devices 21. By rotating the screws at the threaded bolts 23 the transverse beams 7, 9 are correspondingly displaced upwards and downwards. Here the workpiece is deposited on the advantageously horizontally aligned transverse beams 94 and prepared for clamping, whereafter the height and, if necessary, the horizontal alignment of the clamps 3, 5 is carried out by means of the screws such that the points of contact of the clamps 3, 5 are at the desired positions when clamping by means of the threaded spindle 19.

FIG. 9 shows a fifth embodiment of a clamping arrangement on a work plate 100 and a work bench, respectively, or a multifunction table. The work plate 100 has holes 102 in a matrix having predetermined spacing and is part of the clamping arrangement in this embodiment, wherein the work plate 100 replaces the transverse elements 7, 9 of the previous embodiments. The threaded bolts 23 are guided through the holes 102 and their height above the work plate 100 is achieved by rotating the knurled screws 104. The diameter of the knurled screws 104 is significantly greater than the diameter of the holes 102 such that by seating the knurled screws 104 a vertical alignment of the bolts 23 results. The clamps (here only the first clamp 3 is exemplary shown) are vertically aligned by bases 106. Advantageously, the bases 106 have pins protruding downwards such that the bases can be inserted into the holes 102 by the pins.

Further aspects not yet described or further developments or alternatives for single use or in any combination with the above designs are summarized in the following:
preferably, the length of the threaded bolts 23, 48, 76 is shorter than the clamping depth of the screw clamp 3, 5.
the length of the U rails 25 for fitting to the upper ends of the threaded rods for supporting the workpiece and optionally the additions is advantageously the spanning width of the used screw clamps 3, 5. Advantageously, the groove width is the diameter of the used threaded rods such that easy fitting of the U rails to the upper ends of the threaded rods 23, 48, 76 with sufficient retention is possible. The latter, even if the threaded rods are provided with plastic caps. The U rails are ideally configured as a combination of metal (U-shaped opened downwards) as well as wood as the actual support for the workpieces.
the individual transverse beams 7, 9 can be connected to each other in force-locking manner (e.g. by means of longer threaded rods and transversely recessed bore holes).
at the U rail top, a mm scale can be attached for easier positioning.
the threaded pieces can be provided with marks.
with corresponding design, also other clamp types (e.g. one-hand clamp, “infinite” clamp” etc.) can be used.
the screw clamps 3 and/or 5 can be combined with clamping belts such that the flexibility is additionally increased.
the grooves 11 or recesses at the transverse beams 7, 9, respectively, are variabl designed in width and depth (e.g. by means of fixing screws) such that also different clamp models can be used at the same time. And/or the grooves 11 or recesses, respectively, are designed for force-locking fixation of the inserted clamping tools.

The fields of application for the assemblies are:
construction of furniture (in particular making connections by gluing)
production of real wood plates (by gluing individual boards)
areas, in which workpieces have to be fixed, adjusted and clamped (e.g. also for producing bore holes or for screwing workpieces)
   utilization in mobile use, because transportable in place-saving manner)

Further advantages of the assembly are:
universally and flexibly usable
also small workpieces can be clamped without problem
in a symmetrical construction, mutual impediment of clamping tools and additions is avoided
the entire size of the device is solely limited by the size and number of the used screw clamps
the U rails do not have to be necessarily used—thus, also “awkward” workpieces can directly be laid on the upper ends of the threaded rods and be clamped
saving of time and increase of the working efficiency:
once adjusted, arbitrarily many further gluing operations can be performed for similar workpieces very efficiently
only small own size of the individual components, therefore to be stored in place-saving manner
low manufacturing cost and thus also ideally usable in the handyman field.

1. Device for fixing a workpiece, the device comprising:
at least two arms;
at least one clamping axis running between the at least two arms for clamping a workpiece;
at least one connecting element holding the at least two arms spaced apart from each other;
at least one adjusting device for adjusting the position of a workpiece to be clamped relative to the at least one clamping axis, or for adjusting the position of the at least one clamping axis relative to a workpiece to be clamped.

2. Arrangement for fixing a workpiece, the arrangement comprising:
at least two clamping devices wherein each clamping device comprises at least two arms, at least one clamping axis running between the at least two arms for clamping a workpiece, and at least one connecting element holding the at least two arms spaced apart from each other;
at least one adjusting device for adjusting the position of a workpiece to be clamped relative to at least one of clamping axes or for adjusting the position of the at least one clamp axis to a workpiece to be clamped; and
at least one transverse element connecting the at least two clamping devices to each other.

3. Arrangement according to claim 2, wherein the at least one adjusting device is disposed at the at least one of the transverse elements.

4. Device according to claim wherein the at least one adjusting device is disposed at the at least one connecting element.

5. Device according to claim 1, wherein the at least one adjusting device comprises a supporting element for supporting the workpiece, the supporting element having a supporting surface running parallel to the at least one clamping axis.

6. Device according to claim 1, wherein the at least one adjusting device comprises at least one height adjusting means.

7. Device according to claim 6, wherein the height adjusting means includes a threaded section.

8. Device according to claim 5, wherein the supporting element is adjustable in height by at least two height adjusting means.

9. Device according to claim 1, wherein the at least one adjusting device is disposed in shiftable manner at the at least one connecting element.

10. (canceled)

11. Device according to claim 1, wherein the at least one adjusting device comprises an adjusting scale or at least one supporting point.

12. Arrangement according to claim 2, wherein the at least one transverse element comprises at least two recesses spaced apart from each other for inserting at least one of the clamping devices.

13. Arrangement according to claim 12 wherein the fixing elements comprise a fixing means for releasably fixing at least one of the clamping devices.

14. Arrangement according to claim 2, wherein the at least one transverse element, at least one connecting element or at least one adjusting device of a first clamping device connects to an arm at least one connecting element or at least one adjusting device of a second clamping device.

15. Arrangement according to claim 2, wherein at least two adjusting devices are connected by at least one transverse element, wherein the at least two clamping devices are supported on the associated adjusting devices.

16. Arrangement according to claim 2, wherein the at least one transverse element or one or more of the adjusting devices or the connecting element comprises at least base element for standing alignment of the arrangement on a working surface.

17. Arrangement according to claim 2, wherein the arrangement can be disposed on a first side of the workpiece, and in which at least one device or another arrangement disposed on a second side of the workpiece.

18. Arrangement according to claim 17, wherein at least one clamping axis of the arrangement used to clamp the workpiece from the first side is perpendicular to a clamping axis of the at least one device or another arrangement used to clamp the workpiece from the second side.

19. (canceled)

20. Arrangement according to claim 2, wherein the at least one adjusting device is disposed at the at least one transverse element.

21. Arrangement according to claim 2, wherein the at least one adjusting device comprises a supporting element for supporting a workpiece, the supporting element having a supporting surface running parallel to the at least one clamping axis.

22. Arrangement according to claim 2, wherein the at least one adjusting device comprises at least one height adjusting means.

23. Arrangement according to claim 22, wherein the height adjusting means includes a threaded section.

24. Arrangement according to claim 22, wherein a supporting element is adjustable in height by at least two height adjusting means.

25. Arrangement according to claim 2, wherein the at least one adjusting device is disposed in shiftable manner at the at least one transverse element.

26. Arrangement according to claim 25, wherein the transverse element is a work beach, a work plate or a work table.

27. Arrangement according to claim 2, wherein the at least one adjusting device comprises an adjusting scale or at least one supporting point.

28. Device according to claim 1 wherein the device can be disposed on a first side of the workpiece, and in which at least one other device or arrangement is disposed on a second side of the workpiece.

29. Device according to claim 28, wherein at least one clamping device of the device used to clamp the workpiece from the first side is perpendicular to a clamping axis of the at least one other device or arrangement used to clamp the workpiece from the second side.
